(19) United States
(12) Patent Application Publication
(10) Pub. No.: US 2012/0271971 A1
(43) Pub. Date: Oct. 25, 2012

(54) NON-CONTACT SENSING DEVICE AND ITS METHOD FOR COMPUTER PERIPHERALS

(75) Inventor: Ho-Sung WU, New Taipei City (TW)

(73) Assignee: KYE SYSTEMS CORP., New Taipei City (TW)

(21) Appl. No.: 13/448,476

(22) Filed: Apr. 17, 2012

(30) Foreign Application Priority Data
Apr. 20, 2011 (TW) 100113787

(51) Int. Cl. G06F 3/00

(52) U.S. Cl. 710/15

(57) ABSTRACT

A non-contact sensing device for computer peripherals comprises a sensing unit, a controller and a transmitting unit. The sensing unit can detect a digital pointing device and generate a sensing signal. The controller outputs a starting signal and a stopping signal in different time ratios according to the sensing signal and makes the transmitting unit to generate an oscillating signal dynamically to be sent to the digital pointing device. Thereby, the electric power consumed by the non-contact sensing device can be reduced substantially.

### CROSS-REFERENCE TO RELATED APPLICATIONS

This non-provisional application claims priority under 35 U.S.C.§119(a) on Patent Application No(s). 100113787 filed in Taiwan, R.O.C. on Apr. 20, 2011, the entire contents of which are hereby incorporated by reference.

### BACKGROUND

1. Technical Field

The disclosure relates to a sensing device and more particularly to a non-contact sensing device for computer peripherals.

2. Related Art

A common digital panel in the market is used with wireless pointing units. Electromagnetic inductive signals are generated by a wireless pointing unit when the wireless pointing unit is in contact with the digital panel, the coordinates of the wireless pointing unit on the digital panel can be calculated by magnetic coupling, and then the coordinates are sent to a computer.

The wireless pointing unit is capable of being powered by electromagnetic resonance for operation, to avoid the inconvenience caused by the batteries. When the wireless pointing unit receives an electromagnetic resonant signal, the electromagnetic resonant signal is converted into an electromagnetic inductive signal. Then, a pointing signal is generated by the digital panel based on the amplitude of the electromagnetic inductive signal.

The conventional technology provides a switching technique to avoid the interference between the electromagnetic resonant signal and the electromagnetic inductive signal. A digital switch is disposed on the digital panel, so that the digital panel is capable of being switched between the process of transmitting the electromagnetic resonant signal and the process of receiving the electromagnetic inductive signal by the digital switch. Therefore, the coordinate values can be calculated precisely by the digital panel based on the amplitude of the electromagnetic inductive signal.

However, in the conventional technology, the switching between the electromagnetic resonant signal and the electromagnetic inductive signal is performed in a fixed time ratio. Therefore, even if the wireless pointing unit is not placed on the digital panel, the digital panel will still generate the electromagnetic resonant signals continuously. As a result, power is wasted.

### SUMMARY

The present disclosure relates to a non-contact sensing device for computer peripherals used with a digital pointing device. The non-contact sensing device comprises a power supply, a transmitting unit, a sensing unit and a controller. The power supply is configured to generate a power source signal. The transmitting unit is configured to convert the power source signal into an oscillating signal and to send the oscillating signal to the digital pointing device. The sensing unit is configured to receive the oscillating signal sent back from the digital pointing device and to convert the oscillating signal into a sensing signal. And the controller is configured to output a starting signal and a stopping signal with different time ratios to the transmitting unit and the sensing unit, for performing a dynamic switching based on the sensing signal.

The present disclosure further relates to a non-contact sensing method for computer peripherals used with a digital pointing device. The non-contact sensing method comprising steps of: providing a power source signal; converting the power source signal into a oscillating signal and sending the oscillating signal to the digital pointing device; converting the oscillating signal sent back from the digital pointing device into a sensing signal; and outputting a starting signal and a stopping signal with different time ratios based on the sensing signal, so as to perform a dynamic switching.

### BRIEF DESCRIPTION OF THE DRAWINGS

The present disclosure will become more fully understood from the detailed description given herein below for illustration only, and thus are not limitative of the present disclosure, and wherein:

FIG. 1 is block diagram of a non-contact sensing device for computer peripherals of the present disclosure;

FIG. 2 is a timing diagram of signals in the non-contact sensing device for computer peripherals according to a first embodiment of the present disclosure;

FIG. 3 is a timing diagram of signals in the non-contact sensing device for computer peripherals according to a second embodiment of the present disclosure;

FIG. 4 is a timing diagram of signals in the non-contact sensing device for computer peripherals according to a third embodiment of the present disclosure;

FIGS. 5A and 5B are illustrations of a transmitting unit of the present disclosure;

FIGS. 6A and 6B are illustrations of a sensing unit of the present disclosure; and

FIG. 7 is a flow chart of a non-contact sensing method of the present disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

The detailed characteristics and advantages of the disclosure are described in the following embodiments in details, the techniques of the disclosure can be easily understood and embodied by a person of average skill in the art, and the related objects and advantages of the disclosure can be easily understood by a person of average skill in the art by referring to the contents, the claims and the accompanying drawings disclosed in the specifications.

In view of the above problems, some embodiments of the disclosure provide a non-contact sensing device for using with a digital directional device. The non-contact sensing device comprises a power supply, a transmitting unit, a sensing unit and a controller.

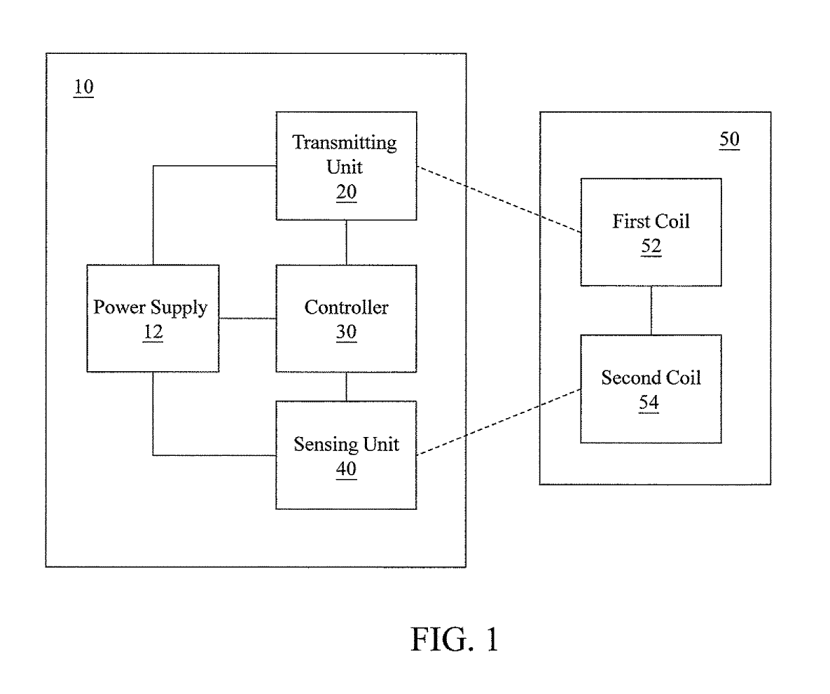

Please refer to FIG. 1. FIG. 1 is block diagram of a non-contact sensing device for computer peripherals according to the first embodiment of this disclosure.

According to the first embodiment, a non-contact sensing device 10 comprises a power supply 12, a transmitting unit 20, a controller 30 and a sensing unit 40. The non-contact sensing device 10 can be a digital panel. The non-contact sensing device 10 is corresponded to a digital pointing device 50 and the digital pointing device 50 is capable of being disposed within the operating area of the non-contact sensing device 10. Once the digital pointing device 50 is controlled by a user, the non-contact sensing device 10 is capable of operating a computer.

The power supply 12 is configured to generate a power source signal and is powered via Universal Serial Bus (USB) or by batteries. The power supply 12 is also capable of be generated by converting an alternating current into a direct current by a transformer.

The power supply 12 is electrically connected to the transmitting unit 20, the controller 30 and the sensing unit 40.

When the transmitting unit 20 receives the power source signal, the power source signal is converted into an oscillating signal, and then the oscillating signal is sent to the digital pointing device 50. When a first coil 52 of the digital pointing device 50 receives the oscillating signal, the oscillating signal is converted into energy for storage, and the oscillating signal is sent to the sensing unit 40 by a second coil 54.

The sensing unit 40 is configured to receive the oscillating signal sent back by the digital pointing device 50 and convert it into a sensing signal.

Based on the sensing signal, the controller 30 outputs a starting signal and a stopping signal in different time ratios to the transmitting unit 20 and the sensing unit 40 for performing a dynamic switching.

The controller 30 is capable of being operated in a first status and a second status. In the first status, the time ratio of the starting signal to the stopping signal is defined as a first ratio. In the second status, the time ratio of the starting signal to the stopping signal is defined as a second ratio. When the controller 30 detects the sensing signal generated by the sensing unit 40, the result indicates that the digital pointing device 50 is disposed within the operating area of the sensing unit 40 and the controller 30 is set to the second status. When the controller 30 does not detect the sensing unit 40, the controller 30 is set to the first status. The proportion of the stopping signal in the first status is larger than that of the stopping signal in the second status.

When the digital pointing device 50 is disposed within the operating area of the sensing unit 40, the sensing unit 40 generates the sensing signal based on the amplitude of the oscillating signal sent back by the digital pointing device 50. The sensing signal indicates the location of the digital pointing device 50.

According to an embodiment of the disclosure, when the transmitting unit 20 receives the starting signal, the transmitting unit 20 is capable of generating the oscillating signal. On the contrary, when the transmitting unit 20 receives the stopping signal, the transmitting unit 20 is capable of stopping the generating of the oscillating signal. In other words, the transmitting unit 20 is capable of generating the oscillating signal discontinuously. Furthermore, the transmitting unit 20 also is capable of generating the oscillating signal with different length of time based on the different ratios (the firs ratio or the second ratio).

Furthermore, when the sensing unit 40 receives the starting signal, the sensing unit 40 generates the sensing signal. On the contrary, when the sensing unit 40 receives the stopping signal, the sensing unit 40 stops generating the sensing signal. Therefore, the electric energy required by the sensing unit 40 can be saved.

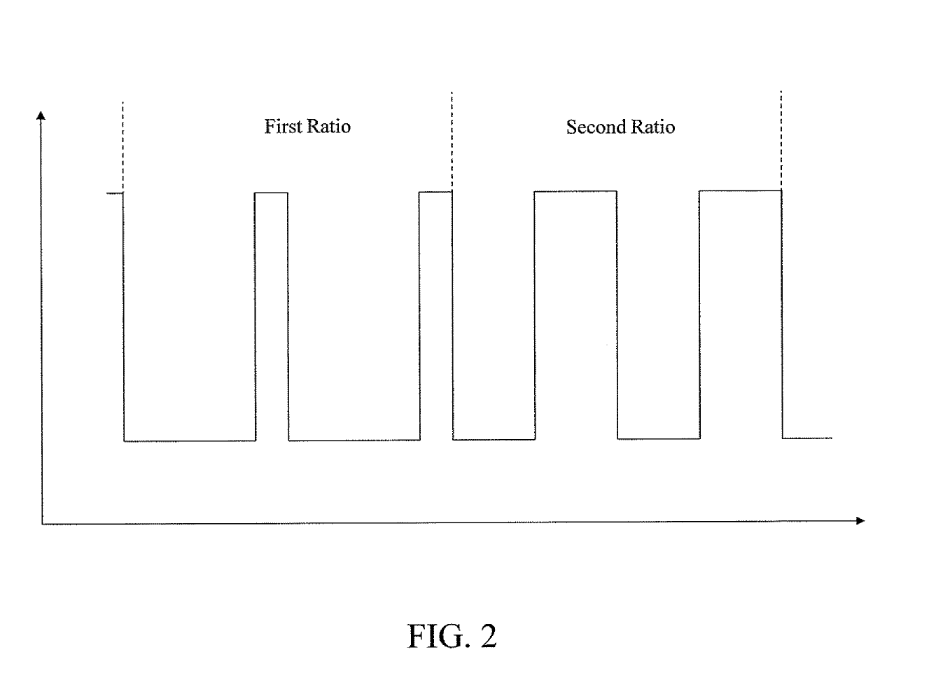

FIG. 2 is a timing diagram of signals in the non-contact sensing device for computer peripherals according to a first embodiment of the disclosure.

As shown in FIG. 2, the starting signal is a high level signal (logic 1) and the stopping signal is a low level signal (logic 0). In the first status, the first ratio of the starting signal to the stopping signal is 20% to 80%. In the second status, the second ratio of the starting signal to the stopping signal is 50% to 50%.

In other words, in the first status, the transmitting unit 20 generates the oscillating signal in only 20% of the time. Therefore, in the first status, the non-contact sensing device 10 is capable of saving a large amount of electric power.

Even though the specific ratios are disclosed in the above embodiment, but it should not be construed as a limitation of the disclosure.

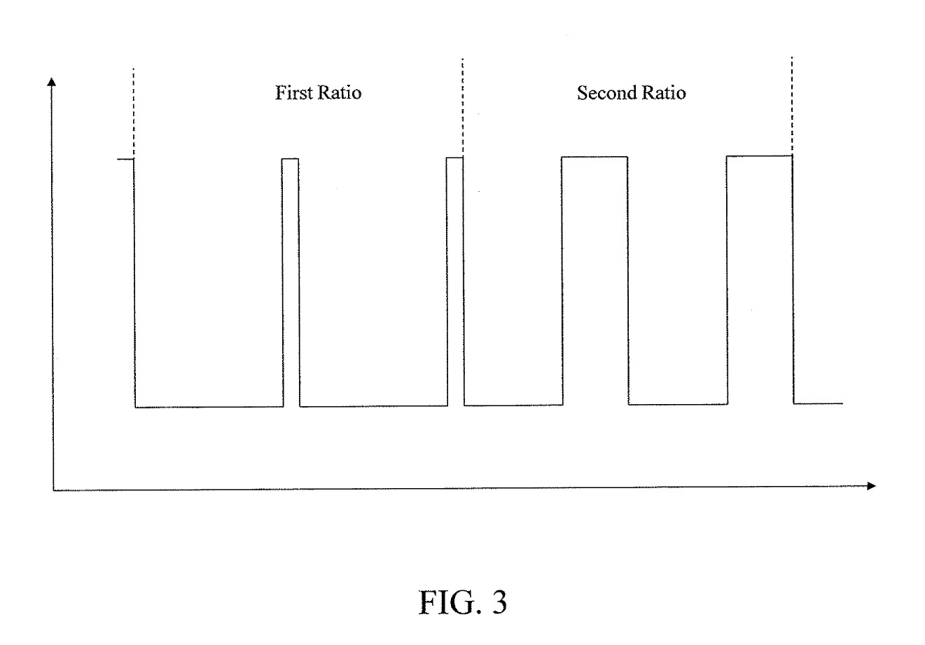

Please refer to FIG. 3, which is a timing diagram of signals in the non-contact sensing device for computer peripherals according to a second embodiment of the disclosure.

In the first status, the first ratio of the starting signal to the stopping signal is 10% to 90%. In the second status, the second ratio of the starting signal to the stopping signal is 40% to 60%.

In the first status, the transmitting unit 20 generates the oscillating signal in only 10% of the time. Therefore, under the first status, the non-contact sensing device 10 is capable of providing a better energy-saving effect.

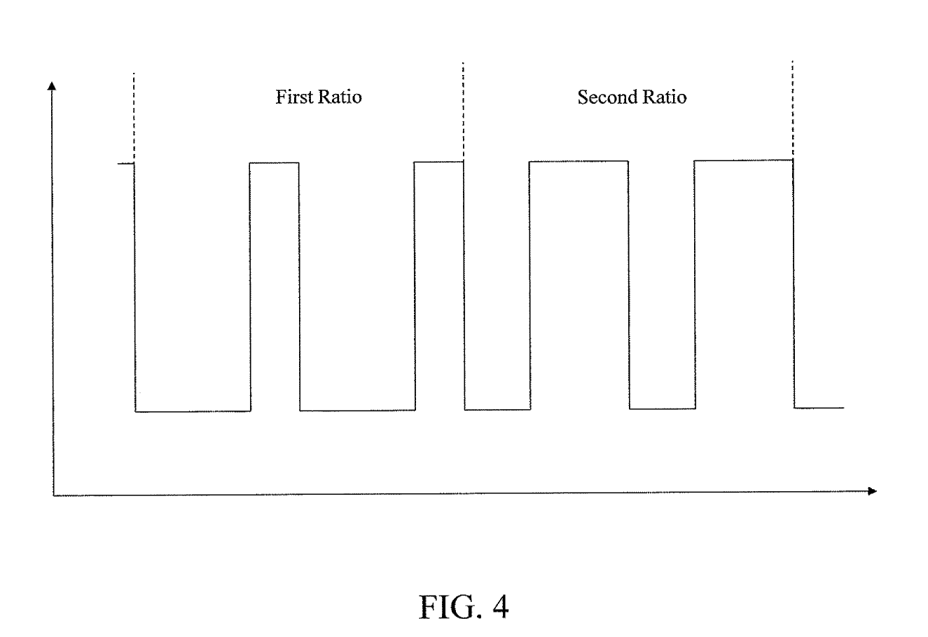

Please refer to FIG. 4, which is a timing diagram of signals in the non-contact sensing device for computer peripherals according to a third embodiment of the disclosure.

In the first status, the first ratio of the starting signal to the stopping signal is 30% to 70%. In the second status, the second ratio of the starting signal to the stopping signal is 60% to 40%.

In the second status, the transmitting unit 20 generates the oscillating signal in 60% of the time. In other words, the digital pointing device 50 is capable of being charged more effectively when it is disposed on the non-contact sensing device 10.

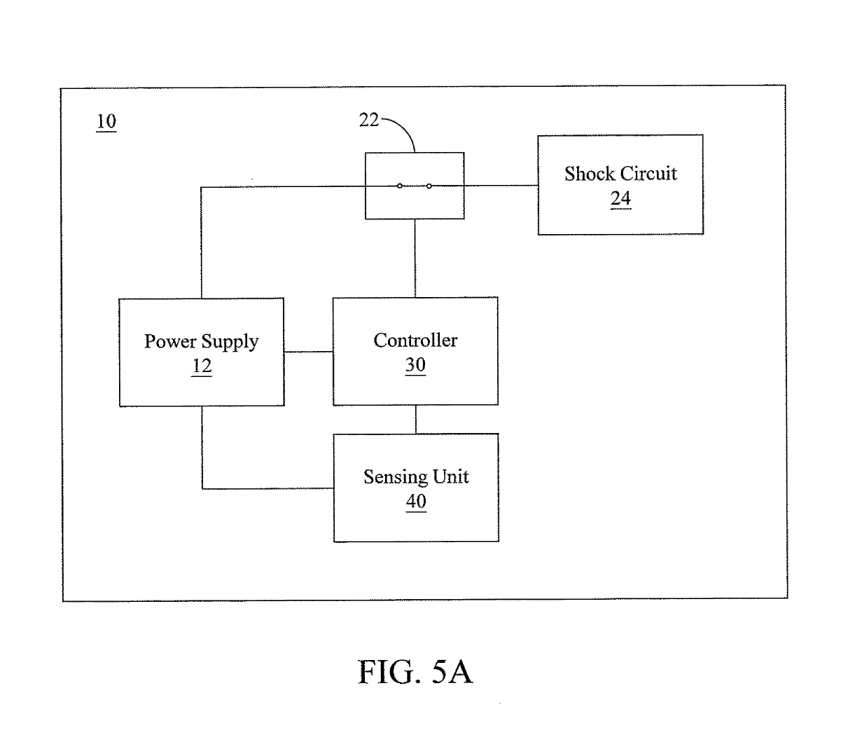

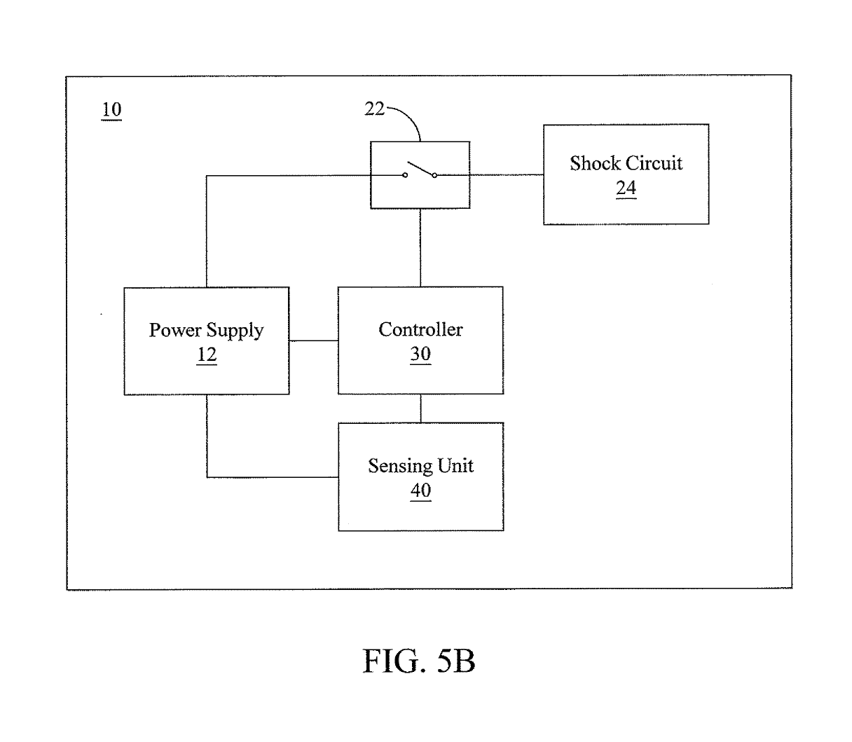

Please refer to FIGS. 5A and 5B, which illustrate the transmitting unit in the present disclosure. The transmitting unit 20 comprises a switch 22 and an oscillating circuit 24. The oscillating circuit 24 and the power supply 12 are capable of being electrically connected by the switch 22. The switch 22 is electrically connected to the controller 30. As shown in FIG. 5A, when the controller 30 outputs the starting signal, the switch 22 electrically connects the power supply 12 to the oscillating circuit 24. As shown in FIG. 5B, when the controller 30 outputs the stopping signal, the switch 22 disconnects the power supply 12 from the oscillating circuit 24.

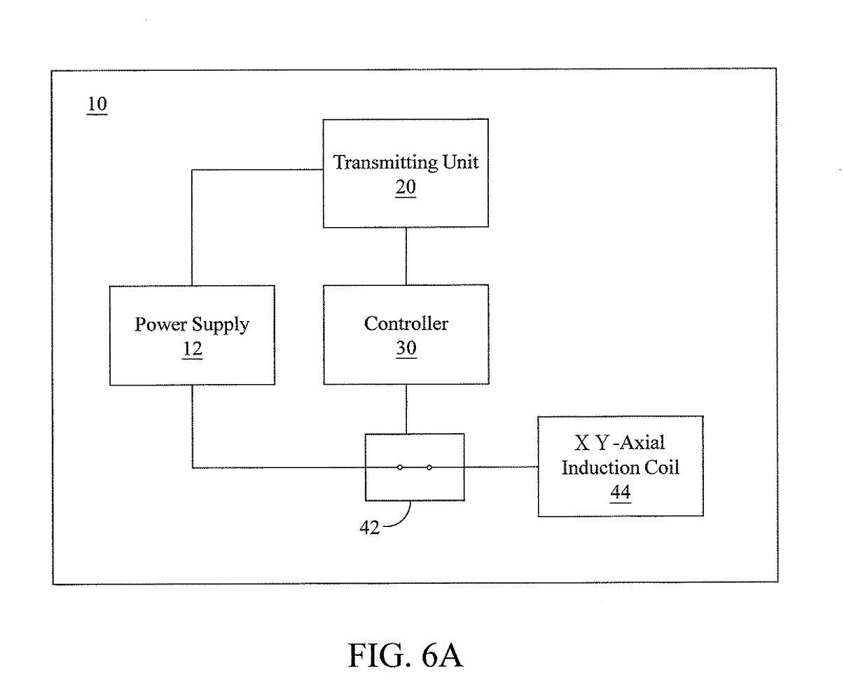

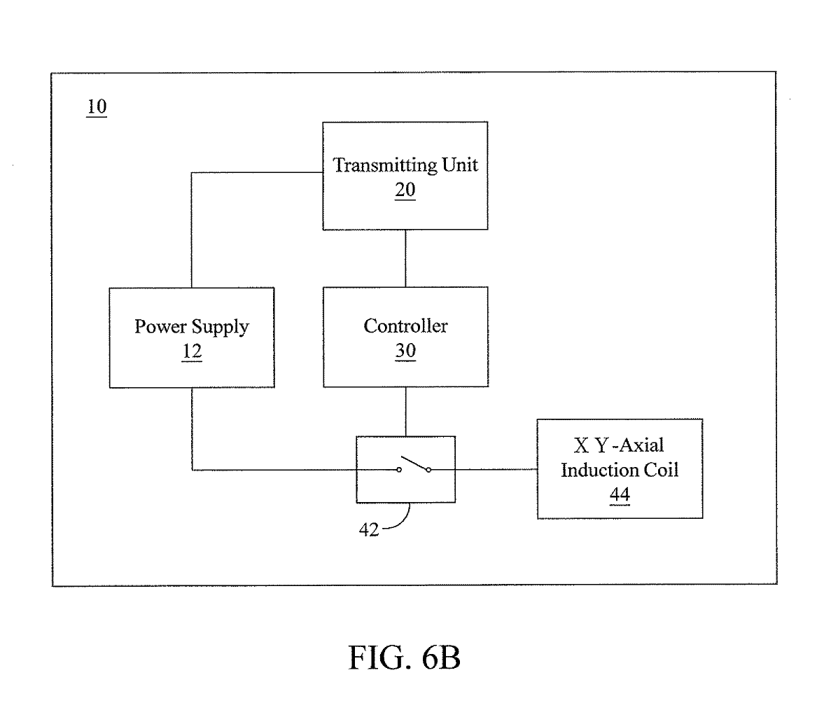

Please refer to FIGS. 6A and 6B, which illustrate the sensing unit in the present disclosure. The sensing unit 40 comprises a switch 42 and a biaxial induction coil 44. The biaxial induction coil 44 and the power supply 12 are capable of being electrically connected by the switch 42. The switch 42 is electrically connected to the controller 30. As shown in FIG. 6A, when the controller 30 outputs the starting signal, the switch 42 electrically connects the power supply 12 and the biaxial induction coil 44. As shown in FIG. 6B, when the controller 30 outputs the stopping signal, the switch 42 disconnects the power supply 12 from the biaxial induction coil 44.

When the digital pointing device 50 is not disposed within the operating area of the sensing unit 40, the time ratio between the starting signal and the stopping signal is capable of being adjusted dynamically, thus the non-contact sensing device 10 only consumes a very little electric power. When the digital pointing device 50 is disposed within the operating area of the sensing unit 40, the time ratio between the starting signal and the stopping signal is also capable of being adjusted dynamically, thus the non-contact sensing device 10 provides an appropriate amount of electric power for the digital pointing device 50. Therefore, the non-contact sensing device 10 is capable of saving a large mount of power.

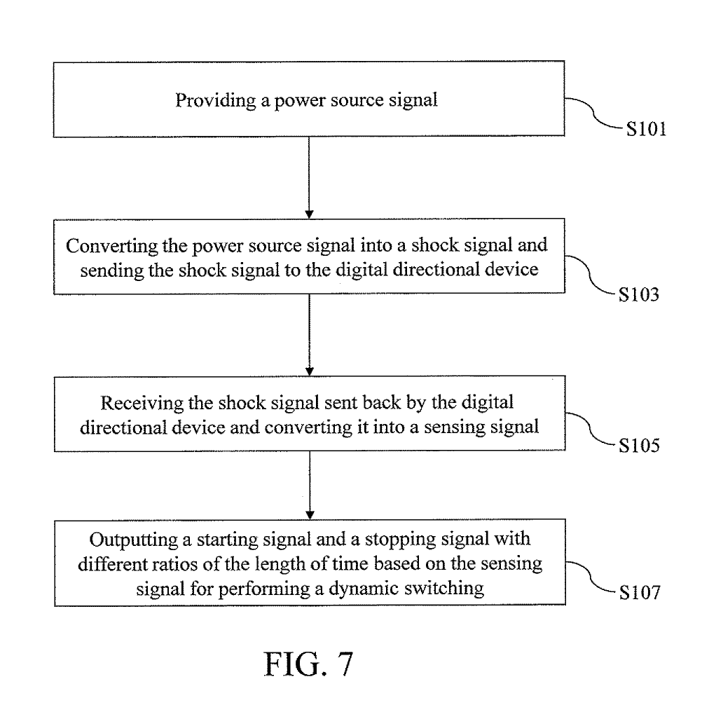

FIG. 7 is a flow chart of a non-contact sensing method in the present disclosure. The non-contact sensing method for computer peripherals in the present disclosure is used with a digital pointing device. The non-contact sensing method comprises following steps. In Step S101, a power source signal is provided. In Step S103, the oscillating signal is converted from the power source signal and is sent to the digital pointing device. In Step S105, the oscillating signal sent back by the digital pointing device is received and is converted into the sensing signal. In Step S107, according to the sensing signal, the starting signal and the stopping signal with different time ratios are output, for performing a dynamic switching.

Using the starting signal and the stopping signal, the dynamic switching is capable of controlling the generating of the oscillating signal and the sensing signal at a different time intermittently.

In the first status and the second status in the non-contact sensing method in the present disclosure, the time ratio of the stopping signal in the first status is larger than the time ratio of the stopping signal in the second status.

Note that the specifications relating to the above embodiments should be construed as exemplary rather than as limitative of the present invention, with many variations and modifications being readily attainable by a person of average skill in the art without departing from the spirit or scope thereof as defined by the appended claims and their legal equivalents.

What is claimed is:

1. A non-contact sensing device for computer peripherals for using with a digital pointing device, the non-contact sensing device comprising:
a power supply for generating a power source signal;
a transmitting unit for converting the power source signal into an oscillating signal and sending the oscillating signal to the digital pointing device;
a sensing unit for receiving the oscillating signal sent back from the digital pointing device and converting the oscillating signal into a sensing signal; and
a controller for outputting a starting signal and a stopping signal with different time ratios to the transmitting unit and the sensing unit, so as to perform a dynamic switching based on the sensing signal.

2. The non-contact sensing device for computer peripherals as claimed in claim 1, wherein the controller has a first status and a second status, the time ratio of the stopping signal in the first status is larger than the time ratio of the stopping signal in the second status.

3. The non-contact sensing device for computer peripherals as claimed in claim 2, wherein when the controller does not detect the sensing signal, the controller is in the first status; when the controller detected the sensing signal, the controller is in the second status.

4. The non-contact sensing device for computer peripherals as claimed in claim 1, wherein the transmitting unit comprises a switch and an oscillating circuit, the oscillating circuit and the power supply are electrically connected by the switch, the switch is electrically connected to the controller, when the controller outputs the starting signal, the switch conducts the power supply and the oscillating circuit, when the controller outputs the stopping signal, the switch disconnects the power supply from the oscillating circuit.

5. The non-contact sensing device for computer peripherals as claimed in claim 1, wherein the sensing unit comprises a switch and a biaxial induction coil, the biaxial induction coil and the power supply are electrically connected by the switch, the switch is electrically connected to the controller,
when the controller outputs the starting signal, the switch connects the power supply to the biaxial induction coil,
when the controller outputs the stopping signal, the switch disconnects the power supply from the biaxial induction coil.

6. The non-contact sensing device for computer peripherals as claimed in claim 1, in the dynamic switching, the controller is configured to output the starting signal to the transmitting unit and to output the stopping signal to the sensing unit simultaneously, or the controller is configured to output the stopping signal to the transmitting unit and the staring signal to the sensing unit simultaneously, when the transmitting unit receives the starting signal, the sensing unit receives the stopping signal, when the transmitting unit receives the stopping signal, the sensing unit receives the starting signal.

7. A non-contact sensing method for computer peripherals used with a digital pointing device, the non-contact sensing method comprising steps of:
providing a power source signal;
converting the power source signal into a oscillating signal and sending the oscillating signal to the digital pointing device;
converting the oscillating signal sent back from the digital pointing device into a sensing signal; and
outputting a starting signal and a stopping signal with different time ratios based on the sensing signal, so as to perform a dynamic switching.

8. The non-contact sensing method for computer peripherals as claimed in claim 7, further comprising a first status and a second status, the time ratio of the stopping signal in the first status being larger than the time ratio of the stopping signal in the second status.

9. The non-contact sensing method for computer peripherals as claimed in claim 7, wherein the dynamic switching is configured to control the generating of the oscillating signal and the sensing signal in different timings intermittently, by using the starting signal and the stopping signal.
